(19) United States
(12) Patent Application Publication
(10) Pub. No.: US 2026/0006466 A1
(43) Pub. Date: Jan. 1, 2026

(54) NETWORK TESTING USING MACHINE LEARNING

(71) Applicant: DISH Wireless L.L.C., Englewood, CO (US)

(72) Inventors: Gurpreet Sohi, Parker, CO (US); Sagar Patel, Highlands Ranch, CO (US); Sundeep Goswami, Leesburg, VA (US); Siddhartha Chenumolu, Ashburn, VA (US)

(21) Appl. No.: 18/756,984

(22) Filed: Jun. 27, 2024

(51) Int. Cl. H04W 24/08; H04L 41/16; H04L 43/50

(52) U.S. Cl. CPC H04W 24/08; H04L 41/16; H04L 43/50

(57) ABSTRACT

Implementations are described herein for network testing using machine learning. In some implementations, a testing system receives a user input regarding a test of a wireless communication system. The testing system identifies, based on the user input, user information and repository information, wherein the user information comprises an intent of the user input and the repository information comprises configuration information that is based on one or more historical tests of the wireless communication system. The testing system determines, based on the user input, the user information, and the repository information, a testing resource for the test of the wireless communication system. The testing system initiates the test of the wireless communication system using the testing resource.

### BACKGROUND

Testing a cellular network, such as a 5G new radio (NR) cellular network, may be crucial for ensuring that the network meets performance, reliability, and interoperability standards. Testing the network may involve evaluating key metrics such as data speed, latency, and an ability of the network to handle high traffic volumes. Testing may be performed across various stages of network deployment, from laboratory environments to field testing, where real-world conditions can be more accurately simulated. Tools and methodologies may be used to test the network infrastructure, identify bottlenecks, and optimize the service for end-users. This process is vital for network operators to deliver a high-quality user experience and comply with regulatory standards.

### BRIEF DESCRIPTION OF THE DRAWINGS

The present disclosure is illustrated by way of example, and not by way of limitation, in the figures of the accompanying drawings.

FIG. 1 is a block diagram of a wireless communication system that includes a network testing system for testing the wireless communication system using machine learning, according to at least one embodiment.

FIGS. 2A-2B are block diagrams of a network testing system for testing a wireless communication system using machine learning, according to at least one embodiment.

FIG. 3 is a flow diagram of an example method of performing a network test using one or more testing resources, according to at least one embodiment.

FIG. 4 is a flow diagram of an example method of performing a network test using machine learning, according to at least one embodiment.

FIG. 5 is a flow diagram of an example method of performing a network test to determine an interoperability between two or more components in a network, according to at least one embodiment.

### DETAILED DESCRIPTION

Technologies for providing network testing using machine learning are described. The following description sets forth numerous specific details, such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Cellular networks, such as 4G, 5G, and 6G networks, are designed to deliver high-speed communication services to mobile and fixed devices. These networks use a complex array of technologies, including advanced radio frequencies and antenna systems, to provide enhanced data throughput, low latency, and increased connectivity to a large number of devices. The networks are configured to support a variety of applications, from simple voice calls to high-definition video streaming and complex machine-to-machine interactions. To ensure these networks operate efficiently and effectively, network testing may be needed. Network testing may be performed, for example, in order to improve interoperability between different devices and network components, ensure the capacity of the network to handle large volumes of traffic, maintain high data throughput rates, and uphold stringent security standards. The network testing process may involve a series of controlled and real-world testing scenarios to assess the performance of the network under various conditions and to identify any potential issues that could impact the user experience or system integrity.

Despite the critical nature of these testing procedures, conventional network testing solutions are inadequate. Conventional network testing processes rely on manual operations that require operators to initiate tests, collect and analyze data, and make decisions about the network performance and configuration. This manual intervention may be time consuming and may increase a likelihood of errors. Additionally, conventional network testing processes may not allow for the testing system to be updated automatically based on a result of the network testing process. Further, conventional network testing processes may not be configured to provide a user with real-time updates regarding a network test initiated by the user. These limitations, among others, may result in reduced network interoperability, capacity, conformance, and security in the network, which may reduce an ability of the network to deliver a fast, reliable, and secure user experience.

Aspects of the present disclosure address the above and other deficiencies by providing a system that implements network testing using machine learning. In some aspects, a network testing system may receive a user input regarding a test of a wireless communication system. A user of the network testing system may access a user portal (such as a web portal) and may input a request to initiate a test of the wireless communication system. In some aspects, the user input may indicate for the network testing system to test a capacity of the wireless communication system, a throughput of the wireless communication system, a security of the wireless communication system, or a connectivity of a device in the wireless communication system, among other examples. The network testing system may identify user information and/or repository information based on the user input. The user information may include an intent of the user input, an artifact associated with the user, and a configuration associated with the user, among other examples. The repository information may include information associated with one or more historical tests of the network and/or may include test suite information, inventory information, and reference stack information, among other examples. The network testing system may determine a testing resource to be used for performing the test of the wireless communication system. For example, the network testing system may analyze the user input, the user information, and/or the repository information and may identify a test resource (such as a test line) for performing the test of the wireless communication system. In some aspects, the network testing system may identify a plurality of test cases to be performed during the test of the wireless communication system. For example, the network testing system may identify multiple phases for the test of the wireless communication system and/or may identify multiple devices or network components to be tested. In some aspects, the network testing system may send an update to the user regarding the test of the wireless communication system. For example, the network testing system may send the user a status report that indicates whether the network test passed or failed, whether a configuration change is recommended for the wireless communication system, and/or whether additional information is needed from the user to complete the test of the wireless communication system.

In some aspects, an artificial intelligence (AI) application associated with the network testing system may identify one or more parameters for the test of the wireless communication system. For example, the AI application may identify a date or time at which the test of the wireless communication system is to be completed, one or more resources to be used for performing the test of the wireless communication system, or a likelihood of the test of the wireless communication system passing or failing. The AI application may determine the one or more parameters using the user input, the user information, and/or the repository information. For example, the AI application may obtain a user input that requests to test a device that is connected to the network testing system, may access repository information or ticketing information that indicates a quantity of tests being performed by the network testing system or a quantity of testing resources that are available at the network testing system, and may provide the user with one or more parameters that indicate an estimated completion date or time for the test of the wireless communication system. In some aspects, the AI application may provide the user with the one or more parameters prior to the test of the wireless communication system being initiated or completed.

In some aspects, the network testing system may include a machine learning (ML) component. The ML component may be configured to analyze test data and to identify configuration changes for the wireless communication system based on analyzing the test data. In some aspects, the ML component may receive a test failure indication associated with a test of the wireless communication system. For example, a testing component of the network testing system may provide the ML component with an indication that the test of the wireless communication system has failed. In some examples, the testing component may provide the ML component with an indication that a throughput of the wireless communication system is below a throughput threshold or may provide the ML component with an indication that a quantity of successful phone calls in the wireless communication system is below a threshold quantity of successful phone calls, among other examples. Additionally, the testing component may provide the ML component with other information, such as the user information, the repository information, or a time at which the test of the wireless communication system was performed. The ML component may store information associated with the test failure. For example, the ML component may store the information received from the testing component as packet capture (PCAP) files. An ML model associated with the ML component may perform a root cause analysis (RCA) of the test failure. For example, the ML model may use the PCAP files and/or other information associated with the test of the wireless communication system to determine a cause of the test failure. The ML component may determine a configuration update for the wireless communication system based on an output by the ML model. For example, the ML component may identify one or more configuration changes for the wireless communication system based on the ML model performing the RCA on the PCAP files. In some aspects, the ML component may train multiple ML models based on the test failure. For example, the ML component may train multiple ML models included in a ML model database using the information included in the PCAP files. The ML component may select an ML model from the ML model database for performing the RCA. For example, the ML model may select the ML model from the ML model library based on one or more features of the ML model and/or one or more features of the PCAP files. In some aspects, the ML component may update a summary in a ticketing system of the network testing system. For example, the ML component may update a time at which the test of the wireless communication system is to be completed. Additionally, or alternatively, the ML component may initiate a new test for the wireless communication system based on the configuration changes.

Some advantages of the present disclosure include improved network testing using machine learning. Some advantages of the present disclosure include decreasing a time for the network test to be performed and increasing an accuracy of the network test. For example, a network testing system may automatically initiate network testing using user inputs, user information, and repository information to improve a speed of the network test and reduce a likelihood of errors during the network test. This may enable increased network interoperability, capacity, conformance, and security in the network, which may increase an ability of the network to deliver a fast, reliable, and secure user experience. Some advantages of the present disclosure include providing a user of the network testing system with updates regarding the test of the wireless communication system. For example, an AI application associated with the network testing system may provide the use with a date or time at which the test of the wireless communication system is to be completed, one or more resources to be used for performing the test of the wireless communication system, or a likelihood of the test of the wireless communication system passing or failing. This may improve a user experience of the network testing system and may increase a quantity of tests performed for the wireless communication system. Some advantages of the present disclosure include using machine learning to update a configuration of the wireless communication system. For example, a machine learning component associated with the network testing system may use test failure information to recommend configuration changes for the wireless communication system and to initiate a new test of the wireless communication system based on the updated configuration. This may increase a success rate for future tests of the wireless communication system. These example advantages, among others, are described in more detail below.

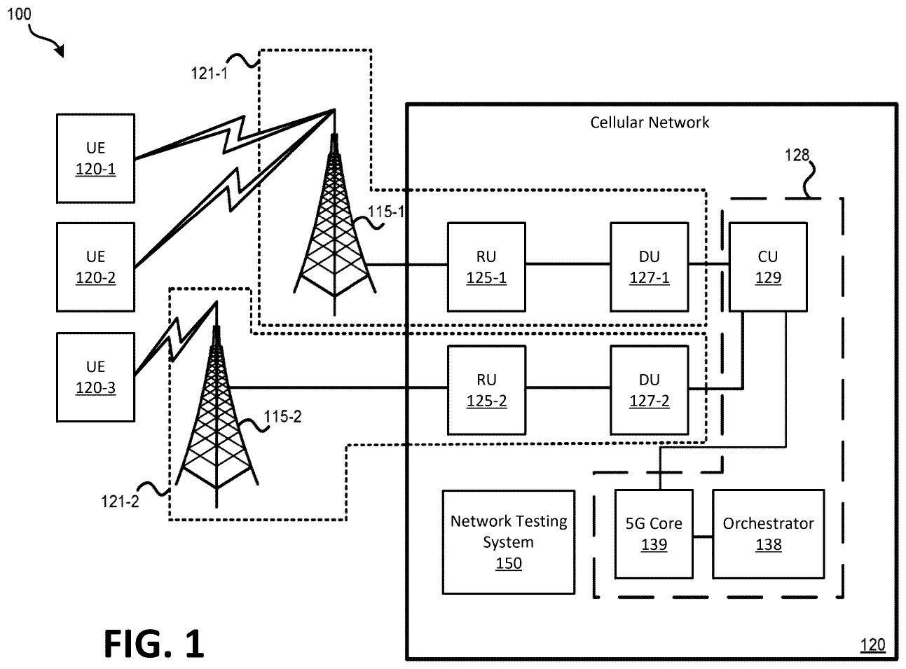

FIG. 1 is a block diagram of a wireless communication system 100 that includes a network testing system 150 for testing the wireless communication system 100 using machine learning, according to at least one embodiment, according to at least one embodiment. The wireless communication system 100 may include a 5G NR cellular network. Other types of cellular networks, such as 4G, 6G, or 7G cellular networks, among other examples, may also be possible. In some aspects, wireless communication system 100 includes one or more user equipments (UEs) 110 (shown as UE 110-1, UE 110-2, and UE 110-3), a base station 115, a cellular network 120, one or more radio units (RU) 125, one or more distributed units (DU) 127, one or more centralized units (CU) 129, a 5G core 139, and an orchestrator 138. In an open radio access network (ORAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider to accommodate a location where the functionality of such components is needed.

The UE 110 can represent various types of end-user devices, such as cellular phones, smartphones, cellular modems, cellular-enabled computerized devices, sensor devices, gaming devices, access points (APs), and computerized devices capable of communicating via the cellular network. Generally, the UE can represent any type of device that has an incorporated 5G interface, such as a 5G modem. Examples can include sensor devices, Internet of Things (IoT) devices, manufacturing robots, unmanned aerial (or land-based) vehicles, and network-connected vehicles, among other examples. Depending on the location of individual UEs, the UE 110 may use RF to communicate with various base stations of the cellular network 120. In some aspects, a first base station (base station 121-1) can include structure 115-1, RU 125-1, and DU 127-1. Structure 115-1 may be any structure to which one or more antennas (not illustrated) of the base station are mounted. For example, structure 115-1 may be a dedicated cellular tower, a building, a water tower, or any other man-made or natural structure to which one or more antennas can reasonably be mounted to provide cellular coverage to a geographic area. A second base station (base station 121-2) can include structure 115-2, RU 125-2, and DU 127-2.

Real-world implementations of the system 100 can include many (e.g., thousands) of base stations and many CUs and 5G core 139. The base station 115 can include one or more antennas that allow the RUs 125 to communicate wirelessly with the UEs 110. The RUs 125 can represent an edge of the cellular network 120 where data is transitioned to a wireless communication. The radio access technology (RAT) used by RU 125 may be 5G NR RAT, or some other RAT. The remainder of the cellular network 120 may be based on an exclusive 5G architecture, a hybrid 4G/5G architecture, a 4G architecture, or some other cellular network architecture. The base station equipment 121 may include an RU (e.g., RU 125-1) and/or a DU (e.g., DU 127-1).

One or more RUs, such as RU 125-1, may communicate with the DU 127-1. As an example, at a cell site, three RUs may be present, each being connected with the same DU. Different RUs may be present for different portions of the spectrum. For example, a first RU may operate on the spectrum in the citizens broadcast radio service (CBRS) band while a second RU may operate on a separate portion of the spectrum, such as, for example, band 71. One or more DUs, such as the DU 127-1, may communicate with the CU 129. Collectively, an RU, DU, and CU create a gNodeB (gNB), which serves as the radio access network (RAN) of the cellular network 120. The CU 129 can communicate with the 5G core 139. The specific architecture of cellular network 120 can vary by embodiment. Edge cloud server systems outside of the cellular network 120 may communicate, either directly, via the Internet, or via some other network, with components of the cellular network 120. For example, the DU 127-1 may be able to communicate with an edge cloud server system without routing data through the CU 129 or the 5G core 139. Other DUs may or may not have this capability.

While FIG. 1 illustrates various components of the cellular network 120, other aspects of the cellular network 120 can vary the arrangement, communication paths, and specific components of the cellular network 120. While RU 125 may include specialized radio access componentry to enable wireless communication with UE 110, other components of the cellular network 120 may be implemented using either specialized hardware, specialized firmware, and/or specialized software executed on a general-purpose server system. In an ORAN arrangement, specialized software on general-purpose hardware may be used to perform the functions of components such as the DU 127, the CU 129, and the 5G core 139. Functionality of such components can be co-located or located at disparate physical server systems. For example, certain components of the 5G core 139 may be co-located with components of the CU 129.

In a possible virtualized ORAN implementation, the CU 129, the 5G core 139, and/or the orchestrator 138 can be implemented virtually as software being executed by general-purpose computing equipment, such as in a data center of a cloud-computing platform. Therefore, depending on needs, the functionality of the CU and/or the 5G core may be implemented locally to each other and/or specific functions of any given component can be performed by physically separated server systems (e.g., at different server farms). For example, some functions of the CU may be located at a same server facility as where the DU is executed, while other functions are executed at a separate server system. In the illustrated embodiment of system 100, cloud-based cellular network components 128 include the CU 129, the 5G core 139, and the orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

In some aspects, Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by the orchestrator 138. The orchestrator 138 can represent various software processes executed by underlying computer hardware. The orchestrator 138 can monitor the cellular network 120 and determine the amount and location at which cellular network functions should be deployed to meet or attempt to meet service level agreements (SLAs) across slices of the cellular network.

The orchestrator 138 can allow for the instantiation of new cloud-based components of the cellular network 120. As an example, to instantiate a new core function, the orchestrator 138 can perform a pipeline of calling the core function code from a software repository incorporated as part of, or separate from, the cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on the cellular network 120. The cellular network 120 may be shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QOS) and quality of experience (QoE) for the UE can be varied on different slices. A network slice can be configured to provide sufficient resources for a particular application to be properly executed and delivered (e.g., gaming services, video services, voice services, location services, sensor reporting services, and data services). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at the RU 125-1 and the DU 127-1, a second set of network slices, which may only partially overlap or may be wholly different from the first set, may be reserved at the RU 125-2 and the DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as the DU 127, the CU 129, the orchestrator 138, and the 5G core 139 may include various software components that are required to communicate with each other, handle large volumes of data traffic, and to properly respond to changes in the network. In order to ensure not only the functionality and interoperability of such components, but also the ability to respond to changing network conditions and the ability to meet or perform above vendor specifications, significant testing may need to be performed.

The 5G core 139, which can be physically distributed across data centers or located at a central national data center (NDC), can perform various core functions of the cellular network. In some aspects, the 5G core 139 may include network resource management components, policy management components, subscriber management components, and packet control components, among other examples. Individual components may communicate on a bus, thus allowing various components of the 5G core 139 to communicate with each other directly. The 5G core 139 is simplified to show some key components. Implementations can involve additional other components.

Network resource management components can include network repository function (NRF) and network slice selection function (NSSF). The NRF can allow the 5G network functions (NFs) to register and discover each other via a standards-based application programming interface (API). The NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). The UDM can allow for generation of authentication vectors, user identification handling, NF registration management, and retrieval of UE individual subscription data for slice selection. The AUSF may perform authentication with the UE.

Packet control components can include access and mobility management function (AMF) and session management function (SMF). The AMF can receive connection- and session-related information from the UE and is responsible for handling connection and mobility management tasks. The SMF is responsible for interacting with the decoupled data plane, creating updating, and removing protocol data unit (PDU) sessions, and managing session context with the user plane function (UPF).

A user plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The 5G core 139 may reside on a cloud computing platform. While from a client or user point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

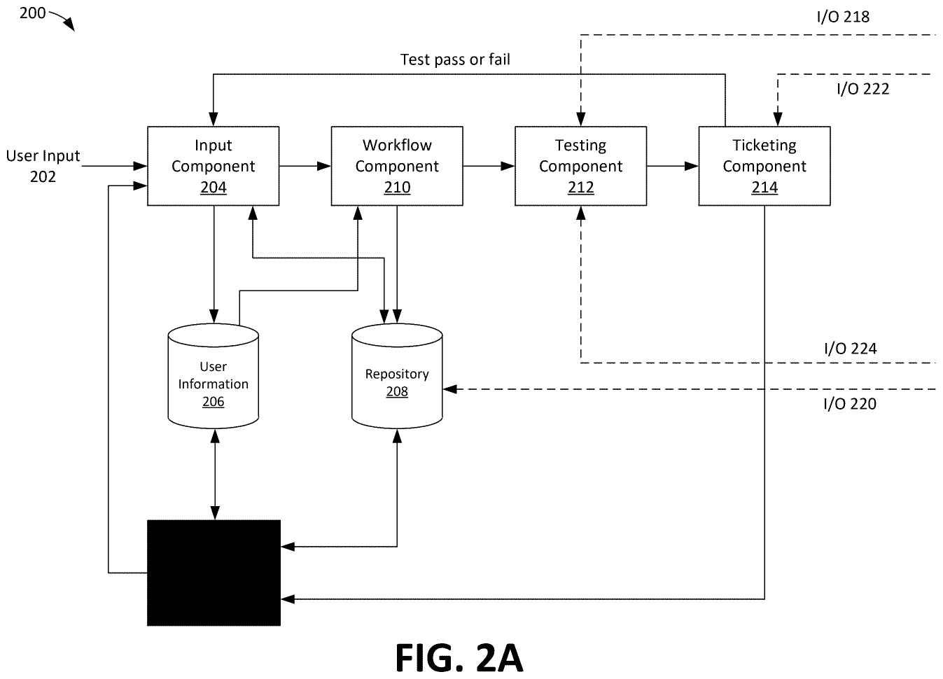

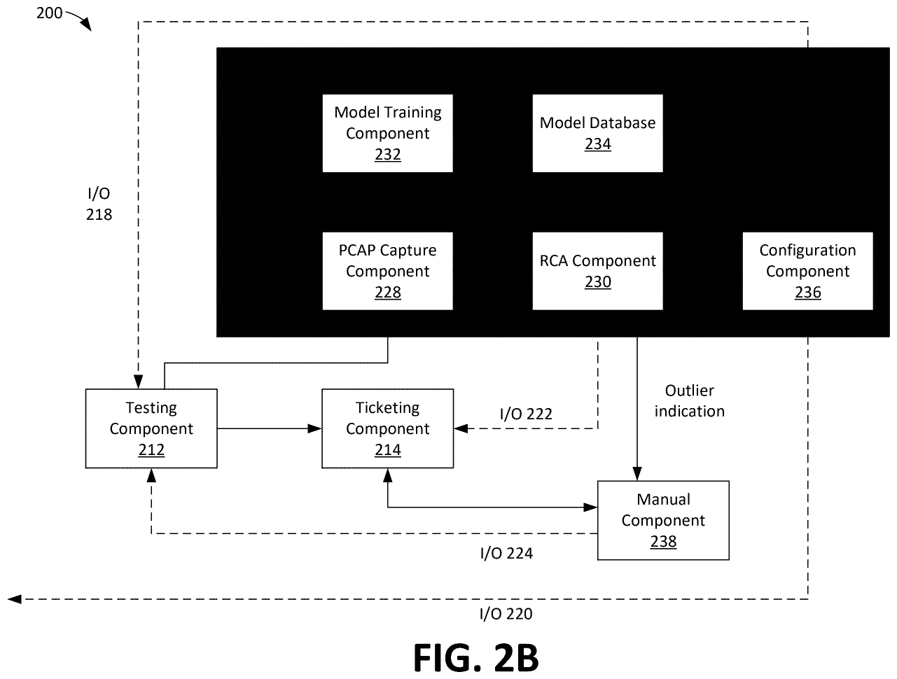

In some aspects, the cellular network 120 includes a network testing system 150 that performs network testing for the cellular network 120. The network testing system 150 may be implemented using one or more processors, one or more memories, and/or one or more non-transitory computer-readable storage mediums. In some aspects, one or more components or systems described in connection with FIGS. 2A-2B may be executed using one or more servers, computers, or data centers, among other examples. The one or more servers, computers, or data centers that implement the one or more components or systems described in connection with FIGS. 2A-2B may be the same, or may be different than, one or more servers, computers, or data centers on which components of the cellular network, such as the cloud-based cellular network components 128 (e.g., the CU 129, 5G core 139, and orchestrator 138), are implemented.

FIGS. 2A-2B are block diagrams of a testing system 200 for testing a wireless communication system using machine learning, according to at least one embodiment. The testing system 200 may be similar or identical to the network testing system 150 described herein. In some aspects, the testing system 200 may be configured to test a performance of the wireless communication system (such as the wireless communication system 100) using one or more machine learning models.

The testing system 200 may enable a user of the testing system 200 to enter a user input 202. The testing system 200 may include an input component 204 that enables the user to enter the user input 202. In some aspects, the input component 204 may include a user portal such as a web-based user portal. For example, the user of the testing system 200 may access the input component 204 via the Internet and may enter the user input 202 using the input component 204. As described herein, the user input 202 may include a request for the testing system 200 to perform one or more tests for the wireless communication system.

In some aspects, the input component 204 may present the user with a login page. The login page may enable the user to authenticate and access the web portal. Additionally, the input component 204 may enable the user to sign up for the testing system 200. For example, the input component 204 may enable the user to create a user account and/or to set up an organization in the web portal (e.g., if the organization has not yet been registered). The input component 204 may present the user with an email address validation page. The email address validation page may enable the user to validate an email address for the user and/or the organization. The input component 204 may enable the user to perform user profile management. For example, the input component 204 may provide the user with a user profile management page that enables the user to add or update a user profile or an organization profile. The input component 204 may enable the user to recover a password. For example, the input component 204 may provide the user with a password recovery page that enables the user to recover a password associated with the user or the organization. The input component 204 may enable the organization to perform organization management. For example, the input component 204 may provide a user or organization with an organization management page that enables an admin to approve and/or manage organizations. The input component 204 may enable the organization to manage users associated with the organization. For example, the input component 204 may provide an organization manager with an organization user management page that enables the organization manager to approve, reject, and/or manage users associated with the organization. The input component 204 may enable the user to initiate a test of the wireless communication system. For example, the input component 204 may provide the user with a page that enables the user to select a project type, such as whether the user wants to test a DU, CU, RU, AMF, UPF, or service management and orchestration (SMO) function, among other examples. Additionally, the input component 204 may provide the user with a page that enables the user to view, select, or enter information to one or more fields, such as to view or indicate a software version, a dimensioning specification, a hardware bill of materials (H-BOM), a software bill of materials (S-BOM), a security certificate, an installation guide, a supported release, and/or a software image, among other examples. The input component 204 may enable the user to view information associated with the network test. For example, the input component 204 may provide the user with a project dashboard page that displays one or more network tests associated with the user or the organization and that indicates a status for the one or more network tests associated with the user or the organization, and/or that enables the user or the organization to initiate a new test. The input component 204 may enable the user to view details associated with the network test. For example, the input component 204 may provide the user with a project details page that displays details about one or more network tests associated with the user or organization.

In some aspects, the input component 204 may determine an intent for the test of the wireless communication system. In one example, the input component 204 may determine that the intent is to test an interoperability between network components. For example, the input component 204 may determine that the intent is to test an interoperability between the RAN, the core network, a CU, a DU, and/or an RU, among other examples. In another example, the input component 204 may determine that the intent is to test a capacity of the network. For example, the input component 204 may determine that the intent is to test a throughput of the wireless communication system over a certain time period. In another example, the input component 204 may determine that the intent is to test a performance of the network (or a performance of one or more features of the network). In another example, the input component 204 may determine that the intent is to test a conformance of the network. For example, the input component 204 may determine that the intent is to test whether one or more network elements or devices confirm with industry standards (such as Third Generation Partnership Project (3GPP) standards). In another example, the input component 204 may determine that the intent is to test a security of the network. In another example, the input component 204 may determine that the intent is to test an end-user device included in the network. For example, the input component 204 may determine that the intent is to test communication reliability between the UE and at least one of the CU, the DU, or the RU. Other examples are possible. In some aspects, the input component 204 may determine multiple intents associated with a test of the wireless communication system. In some aspects, the input component 204 may determine an environment in which the test is to be performed. For example, the input component 204 may determine whether the test is to be performed in a lab (e.g., before the device is deployed) or in the field (e.g., after the device is deployed). In some aspects, the input component 204 may determine a quantity of nodes that are to be tested during the test of the wireless communication system. For example, the input component 204 may determine that x RUs, y DUs, and z CUs are to be tested.

The testing system 200 may include user information 206 and a repository 208. The user information 206 may be, may include, or may be included in, a database that stores information associated with a plurality of users or organizations of the testing system 200. In some aspects, the user information 206 may include artifacts, a configuration, and/or an intent associated with one or more users of the plurality of users. The repository 208 may be a database that stores information associated with the testing system 200. In some aspects, the repository 208 may include test suite information, inventory information, and/or reference stack information. The input component 204 may access the user information 206 and/or the repository 208 for determining the intent for the test of the wireless communication system. Additionally, a workflow component 210 of the testing system 200 may access the user information 206 and the repository 208 for preparing the test of the wireless communication system.

The workflow component 210 may be configured to gather and prepare testing information for a test of the wireless communication system. The workflow component 210 may receive inputs from the input component 204, the user information 206, and/or the repository 208. The workflow component 210 may schedule a test line and one or more test resources for the test of the wireless communication system based on the inputs. In some aspects, the workflow component 210 may check whether the test line is available and has end-to-end connectivity. If the test line is busy, for example, being used to execute other tests, the workflow component 210 may add the request to a queue. In some aspects, the workflow component 210 may setup a compute server with drivers, firmware, and other configuration information based on the inputs and the test line. Additionally, the workflow component 210 may onboard one or more artifacts from the repository and may integrate the artifacts on the compute server. In some aspects, the workflow component 210 may identify a list of test cases to be executed from a library of test cases based on the inputs (for example, based on the intent).

A testing component 212 of the testing system 200 may be configured to perform the test of the wireless communication system. The testing component 212 may receive an input from the workflow component 210 and may initiate execution of one or more test cases on the identified test line. The testing component 212 may identify one or more test cases to be performed for the test of the wireless communication system based, for example, on the intent. In one example, the testing component 212 may determine that, in order to test a capacity of the wireless communication system, multiple test cases may need to be performed, where each test case measures a throughput of the wireless communication system at a certain time period. In another example, the testing component 212 may determine that, in order to test a security of the wireless communication system, multiple test cases may need to be performed, where each test case measures a security of a select device in the wireless communication system. In another example, the testing component 212 may determine that, in order to perform end-user device testing, multiple test cases may need to be performed, where each test case tests a select end-user device associated with the wireless communication system. Other examples are possible. The testing component 212 may identify configuration changes for the wireless communication system via a management plane in the network functions required for the test cases. In some aspects, the testing component 212 may determine whether the test passed or failed based on test criteria (for example, pass or fail criteria) associated with test case. If the test passed (for example, if the test was successful), the testing component 212 may initiate another test (such as a next test in a queue). If the test failed (for example, if the test was not successful), the testing component 212 may capture packet capture (PCAP) files and logs for each of the failed test cases. The testing component 212 may update a test case library based on the test passing or failing and/or based on initiating another test for the wireless communication system. In some aspects, the testing component 212 may the test pass (a test pass condition) or the test failure (a test fail condition) to a ticketing system 214.

The testing system 200 (for example, the ticketing system 214) may provide feedback to the user based on a completion of the test. The feedback to the user may indicate when the test is complete or when a portion of the test (such as a first round of testing) is complete. In some aspects, the feedback may be a report that is sent to the user after all test cases have completed (for example, passed). The report may include one or more stats, such as stats that indicate the pass and fail numbers for the test, and/or may include a summary that indicates one or more log files for each test (or test case) performed by the testing system 200. In some aspects, the feedback may include ticket details indicating that further analysis is required, or that additional information is needed from the user. In some aspects, the feedback may include one or more configuration changes for the wireless communication system. The configuration changes may be configuration changes that are generated by a machine learning model, as described below.

In one example, the testing system 200 may test a capacity of the wireless communication system. The input component 204 may receive a user input 202 that indicates for the testing system 200 to test the capacity of the wireless communication system. The input component 204 may access information from the user information 206 and the repository 208 and may determine one or more characteristics for the test of the wireless communication system. For example, the input component may determine that the intent of the user input 202 is to test the capacity of the wireless communication system, may determine an environment for testing the wireless communication system (e.g., in the field), and may determine a number of devices to be tested (e.g., one hundred end-user devices (such as cell phones) communicating with an RU). The workflow component 210 may schedule a test line and one or more testing resources to be used for testing the capacity of the wireless communication system. The testing component 212 may initiate and perform the test for the wireless communication system and may provide the ticketing system 214 with an indication of whether the test passed (was successful) or failed (was not successful). In some aspects, the testing system 200, to test the capacity of the wireless communication system, may test whether a percentage of phone calls by the end-user devices satisfies a successful call percentage threshold. The quantity of end-user devices may be one hundred end-user devices each making one phone call to the RU, where 96 of the phone calls are successful and 4 percent of the phone calls are not successful. In a first example, the successful call threshold may be 95 percent. In this example, the testing system 200 may determine that the test passed (was successful) since the percentage of successful phone calls (96 percent) is greater than the successful call percentage threshold (95 percent). The ticketing system 214 may send, to the input component 204, and indication that the test passed. In a second example, the successful call threshold may be 98 percent. In this example, the testing system 200 may determine that the test failed (was not successful) since the percentage of successful phone calls (96 percent) is less than the successful call percentage threshold (98 percent). The ticketing system 214 may send, to the input component 204, and indication that the test failed. Additionally, the testing component 212 may send an indication of the test failure to an ML system 226 (described in more detail below).

In another example, the testing system 200 may test a security of the wireless communication system. The input component 204 may receive a user input 202 that indicates for the testing system 200 to test the security of the wireless communication system. The input component 204 may access information from the user information 206 and the repository 208 and may determine one or more characteristics for the test of the wireless communication system. For example, the input component may determine that the intent of the user input 202 is to test the security of the wireless communication system, may determine an environment for testing the wireless communication system (e.g., in the lab), and may determine a number of devices to be tested (e.g., one CU, one DU, and one RU). The workflow component 210 may schedule a test line and one or more testing resources to be used for testing the security of the wireless communication system. The testing component 212 may initiate and perform the test for the wireless communication system and may provide the ticketing system 214 with an indication of whether the test passed (was successful) or failed (was not successful). In some aspects, the testing system 200, to test the security of the wireless communication system, may perform one or more of vulnerability scanning, authentication and authorization testing, encryption testing, intrusion detection and prevention testing, and security policy compliance testing, among other examples, for each device in the wireless communication system to be tested. In order for the security test to pass (be successful), all devices being tested may need to pass the security tests. Otherwise, the test will be considered a failure (not successful). In a first example, each of the CU, DU, and RU may pass all of the tests performed by the testing component 212. In this example, the ticketing system 214 may send, to the input component 204, and indication that the test passed. In a second example, the CU may pass all of the tests performed, but the DU may fail the encryption test and the RU may fail the security policy compliance test. In this example, the ticketing system 214 may send, to the input component 204, and indication that the test failed. Additionally, the testing component 212 may send an indication of the test failure to the ML system 226 (described in more detail below).

In some aspects, the system 200 includes AI application 216. The AI application 216 may receive one or more inputs from the input component 204, user information 206, the repository 208, and/or the ticketing system 214. The AI application 216 may identify one or more parameters for the test of the wireless communication system using the one or more inputs. In some aspects, the one or more parameters may include a date or a time at which the test is to be initiated or completed. For example, the AI application 216 may obtain test data from the input component 204 (and/or the user information 206), may obtain capacity information associated with the testing system 200 from the ticketing system 214 (such as a quantity of other tests being performed by the system 200 or a quantity of testing resources that are available), and may generate an output that indicates the date or the time (for example, an estimated date or time) at which the test is to be initiated or completed. In some aspects, the one or more parameters may include a likelihood of the test passing or a likelihood of the test failing. For example, the AI application 216 may obtain testing information from the input component 204 (and/or the user information 206), may obtain historical test information associated with the testing system 200 from the ticketing system 214 (such as whether historical and similar tests performed by the testing system 200 have passed or failed), and may generate an output that indicates the likelihood of the test passing or the likelihood of the test failing. The AI application 216 may provide one or more outputs to the input component 204. Providing the outputs to the input component 204 may enable the user of the testing system 200 to view information associated with the test prior to the test being completed (and/or initiated).

The ML system 226 (which may be referred to as the ML component) may be configured to provide or recommend configuration updates for the wireless communication system. The ML system 226 may include a PCAP capture component 228, an RCA component 230, a model training component 232, a model database 234, and a configuration component 236. The testing component 212 may send, to the PCAP capture component 228, an indication of a test failure. For example, the testing component 212 may detect that a test performed by the testing system 200 failed (was not successful) and may send an indication of the test failure to the PCAP capture component 228. In some aspects, the testing component 212 may provide PCAP files and logs to the PCAP capture component 228. Additionally, or alternatively, the PCAP capture component 228 may extract the PCAP files and logs from the failure indication provided by the testing component 212. The PCAP capture component 228 may store the PCAP files and logs in a repository.

The RCA component 230 may perform an RCA based on the PCAP files and logs. For example, the RCA component 230 may use the PCAP files and/or other information associated with the test of the wireless communication system to determine a cause of the test failure. Performing the RCA based on the PCAP files and logs may include performing one or more of the following: defining the failure (such as whether the failure is based on network throughput requirements or unexpected drops in connectivity), collecting data (such as gathering logs, test configurations, environmental conditions, and any changes made to the system before the test), analyzing the data (such as using a fault tree analysis), identifying contributing factors (such as hardware malfunctions, software bugs, improper configuration settings, or external interference), and/or identifying possible changes (such as updating software, replacing faulty hardware, changing configuration settings, or shielding the system from external interferences).

The model training component 232 may be configured to train one or more ML models associated with the testing system 200. The model training component 232 may train the one or more ML models based on the collected data, such as based on the PCAP files or the logs. For example, the model training component 232 may receive a result of the RCA and may determine one or more failure parameters based on the result of the RCA. Additionally, the model training component 232 may identify one or more corresponding model parameters in the one or more ML models and may update the one or more model parameters based on the one or more failure parameters. The model database 234 may store the one or more models. For example, the model database 234 may receive the updated ML models from the model training component 232 and may store the updated ML models.

The configuration component 236 may determine one or more configuration changes for the wireless communication system. The configuration component 236 may receive an input from the RCA component 230 that includes a result of the RCA for the test failure. The configuration component 236 may determine one or more configuration changes for the wireless communication system based on the input from the RCA component 230. In some aspects, the configuration changes may be based on the intent of the test of the wireless communication system. In one example, the intent of the wireless communication system may be to test the capacity of the wireless communication system. The configuration component 236 may identify that the capacity test for the wireless communication system failed and may determine one or more configuration changes for the wireless communication system to improve the capacity of the wireless communication system (such as to dedicate more resources for data communication). In another example, the intent of the wireless communication system may be to test the security of the wireless communication system. The configuration component 236 may identify that the security test of the wireless communication system failed and may determine one or more configuration changes for the wireless communication system to improve the security of the wireless communication system (such as to update an encryption for communicating with a node of the wireless communication system).

In some examples, the RCA component 230 may not be able to perform RCA for the test failure. For example, the ML system 226 may not be trained on parameters that resulted in the test failure, resulting in the RCA component 230 not being able to perform the RCA. In this example, the RCA component 230 may send an outlier indication to a manual component 238. The outlier indication may indicate one or more outliers corresponding to one or more test failures for which the RCA component 230 was not able to perform RCA. The manual component 238 may enable an operator to manually determine a cause of the test failure and/or to recommend one or more configuration changes based on the test failure. The manual component 238 may generate an output to the testing component 212 and/or the ticketing system 214 that indicates the cause of the test failure and/or the one or more configuration changes.

One or more components included in the ML system 226 may be configured to output information to one or more other components of the testing system 200. In some aspects, the configuration component 236 may output one or more recommended configuration changes to the testing component 212 (shown as input/output (I/O) 218). In some aspects, the configuration component 236 may output one or more recommended configuration changes to the repository 208 (shown as I/O 220). In some aspects, the RCA component 230 may output a result of the RCA associated with the test failure to the ticketing system 214 (shown as I/O 222). In some aspects, the manual component 238 may output one or more recommended configuration changes to the testing component 212 (shown as I/O 224). This may enable improved performance by the testing system 200, for example, by updating one or more components of the testing system 200 based on outputs of the ML system 226.

In some aspects, one or more components of the testing system 200 may test an interoperability between an interface of a wireless communication system and one or more components of the wireless communication system. For example, the input component 204 may receive a user input regarding a test of the wireless communication system that indicates for the testing system 200 to test the interoperability between the interface and the one or more components of the wireless communication system. The testing component 212 may determine one or more parameters for the test of the wireless communication based on the user input. The testing component 212 may perform a test using the one or more parameters and may generate an output that indicates the interoperability between the interface and the one or more components.

In some aspects, the wireless communication system may be an ORAN wireless communication system. In these aspects, the interface may be an ORAN interface. Additionally, or alternatively, the one or more components may include one or more other ORAN interfaces. In some aspects, the test for the interoperability between the interface and the one or more components may be performed within a testing environment or a laboratory environment, such as within an environment that includes the testing system 200.

In some aspects, the interface may be an open fronthaul (OFH) interface. Therefore, the testing component 212 may test an interoperability between the OFH interface and the one or more other components. The OFH interface may be a management plane (M-Plane) interface, a control plane (C-Plane) interface, a user plane (U-Plane) interface, or a synchronization plan (S-Plane) interface. The M-Plane interface may be used to manage and configure an RU. The C-Plane interface may be used to manage control information between a DU and an RU. The U-Plane interface may be used to transmit user data between the DU and the RU. The S-Plane interface may be used to perform time synchronization between the DU and the RU.

In some aspects, the interface may be an open midhaul (OMH) interface. Therefore, the testing component 212 may test an interoperability between the OMH interface and the one or more other components. The OMH interface may be an F1 interface. The Fl interface may connect the DU and the CU. The F1 interface may be, or may include, at least one of a control plane (F1-C) interface or a user plane (F1-U) interface.

In some aspects, the interface may be an open backhaul (OBH) interface. Therefore, the testing component 212 may test an interoperability between the OBH interface and the one or more other components. The OBH interface may be an NG interface. The NG interface may connect the CU to a core network (such as a 5G core network). The NG interface may be, or may include, at least one of a control plane (NG-C) interface or a user plane (NG-U) interface.

In some aspects, the interface may be a RAN intelligent controller (RIC) interface. Therefore, the testing component 212 may test an interoperability between the RIC interface and the one or more other components. The RIC interface may be an E2 interface or an A1 interface. The E2 interface may be used to connect a near-real-time RIC (near-RT RIC) with the DU and CU. The A1 interface may be used to connect a non-real-time (non-RT RIC) with the near-RT RIC for policy management and optimization.

In some aspects, the interface may be a service management and orchestration (SMO) interface. Therefore, the testing component 212 may test an interoperability between the SMO interface and the one or more other components. The SMO interface may be an O1 interface or an O2 interface. The O1 interface may be used to connect the SMO with the ORAN elements (e.g., the RU, DU, or CU) for management functions such as fault, configuration, accounting, performance, and security management. The O2 interface may be used to connect the SMO with cloud infrastructure, for example, to manage the resources and lifecycle of the ORAN components deployed in a cloud-native environment.

In some aspects, the interface may be an Xn interface. Therefore, the testing component 212 may test an interoperability between the Xn interface and the one or more other components. The Xn interface may be used in 5G networks to connect gNBs for inter-cell coordination.

In some aspects, the one or more parameters may include a functional testing parameter. The testing component 212 may use the functional testing parameter to verify that two or more devices can perform intended functions correctly when interacting with each other. This may include checking basic operations such as establishing connections, data transfer, and handovers.

In some aspects, the one or more parameters may include a protocol testing parameter. The testing component 212 may use the protocol testing parameter to ensure that the communication protocols used by the devices are compatible. This may involve testing signaling messages, error handling, and protocol compliance.

In some aspects, the one or more parameters may include a performance testing parameter. The testing component 212 may use the performance testing parameter to assess the performance of the devices under various conditions, such as different network loads, mobility scenarios, and interference levels. This may help to identify any performance bottlenecks or issues.

In some aspects, the one or more parameters may include a security testing parameter. The testing component 212 may use the security testing parameter to evaluate the security aspects of the devices and their interactions. This may include checking for vulnerabilities, encryption compatibility, and secure communication protocols.

In some aspects, the output that indicates the interoperability between the interface and the one or more components may include a pass condition or a fail condition. The pass condition may indicate that the interface and the one or more components are able to communicate with no issues or with minimal issues. The fail condition may indicate that there are significant problems preventing the interface and the one or more components from communicating successfully.

In some aspects, the output that indicates the interoperability between the interface and the one or more components may include a value that indicates a level of interoperability between the interface and the one or more components. For example, a first value may indicate a basic interoperability between the interface and the one or more components. The basic interoperability may indicate that the interface and the one or more components can establish a connection and perform basic functions. A second value may indicate an intermediate interoperability between the interface and the one or more components. The intermediate interoperability may indicate that the interface and the one or more components can perform more advanced functions and maintain a stable connection under various conditions. A third value may indicate a full interoperability between the interface and the one or more components. The full interoperability may indicate that the interface and the one or more components can perform all intended functions seamlessly, with high performance and reliability. Other values and interoperability metrics are possible.

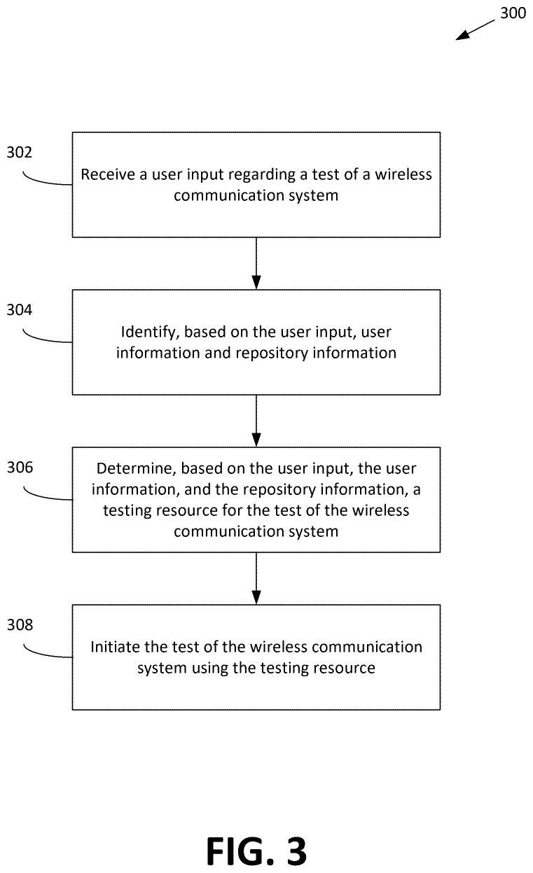

FIG. 3 is a flow diagram of an example method 300 of performing a network test using one or more testing resources, according to at least one embodiment. The method 300 may be performed by processing logic that may comprise hardware (e.g., circuitry, dedicated logic, programmable logic, microcode, etc.), software (such as instructions running on the processor), firmware, or a combination thereof. In one embodiment, a processor of the testing system 200 performs the method 300. Alternatively, other components of the testing system 200, or other disclosed devices, may perform some or all of the operations of the method 300.

With further reference to FIG. 3, the method 300 begins with the processing logic receiving a user input regarding a test of a wireless communication system (block 302). The processing logic identifies, based on the user input, user information and repository information (block 304). The user information comprises an intent of the user input and the repository information comprises configuration information that is based on one or more historical tests of the wireless communication system. The processing logic determines, based on the user input, the user information, and the repository information, a testing resource for the test of the wireless communication system (block 306). The processing logic initiates the test of the wireless communication system using the testing resource (block 308).

In some implementations, the user input regarding the test of the wireless communication system indicates to test at least one of an interoperability between two or more nodes in the wireless communication system, a capacity of the wireless communication system, a performance metric of the wireless communication system, a conformance of the wireless communication system, a security of the wireless communication system, or a device that is communicating with the wireless communication system.

In some implementations, the processing logic identifies, based on the user input, the user information, and the repository information, an environment for performing the test of the wireless communication system or a quantity of nodes to be tested during the test of the wireless communication system.

In some implementations, determining the testing resource for the test of the wireless communication system comprises determining whether the testing resource is available and has end-to-end connectivity. In some implementations, the processing logic adds the test of the wireless communication system to a queue based on the testing resource not being available or not having end-to-end connectivity.

In some implementations, initiating the test of the wireless communication system comprises sending, to a test orchestration and reporting component, an indication to initiate the test of the wireless communication system, wherein the indication to initiate the test of the wireless communication system comprises at least one of driver information or firmware information for the test of the wireless communication system.

In some implementations, the processing logic identifies, based on the intent of the user input and a set of test cases associated with the wireless communication system, a plurality of test cases in the set of test cases to be performed during the test of the wireless communication system.

In some implementations, the processing logic generates an output that indicates a pass condition for the test of the wireless communication system or an output that indicates a fail condition for the test of the wireless communication system.

In some implementations, the user information further comprises at least one of artifact information or configuration information associated with a user of the wireless communication system.

In some implementations, the repository information further comprises at least one of test suite information, inventory information, or reference stack information.

In some implementations, the processing logic sends, to a user associated with the user input, an indication of a date or a time at which at least a portion of the test is to be completed.

In some implementations, the processing logic sends, to a user associated with the user input, after a completion of the test of the wireless communication system, a status indicator for the test of the wireless communication system and summary report for the test of the wireless communication system. In some implementations the summary report indicates, for each test case of a plurality of test cases associated with the test of the wireless communication system, an indication of a pass condition for the test case or an indication of a fail condition for the test case and an indication of one or more log files for the test case.

In some implementations, the processing logic adds the test of the wireless communication system to a ticketing system based on additional information being needed to complete the test of the wireless communication system.

In some implementations, the processing logic generates an output that indicates one or more configuration changes to the wireless communication system based on a fail condition for the test of the wireless communication system.

In some implementations, the processing logic identifies, using a machine learning model, based on the user input, the user information, and the repository information, one or more parameters for the test of the wireless communication system. In some implementations, the one or more parameters for the test of the wireless communication system include a date or a time at which the test of the wireless communication system is to be performed. In some implementations, the one or more parameters for the test of the wireless communication system include a likelihood of a pass condition for the test of the wireless communication system or a likelihood of a fail condition for the test of the wireless communication system.

In some implementations, the processing logic sends, to a user associated with the user input, prior to completing the test of the wireless communication system, an indication of the one or more parameters for the test of the wireless communication system.

In some implementations, the processing logic accesses ticketing information that indicates at least one of a quantity of other tests being performed and a quantity of testing resources that are available.

In some implementations, a system comprises one or more processors, and one or more memories, coupled with the one or more processors, storing processor-readable instructions which, when executed by the one or more processors, cause the one or more processors to perform one or more operations of the method 300.

In some implementations, a non-transitory computer-readable storage medium comprises instructions that, when executed by a processing device, cause the processing device to perform operations one or more operations of the method 300.

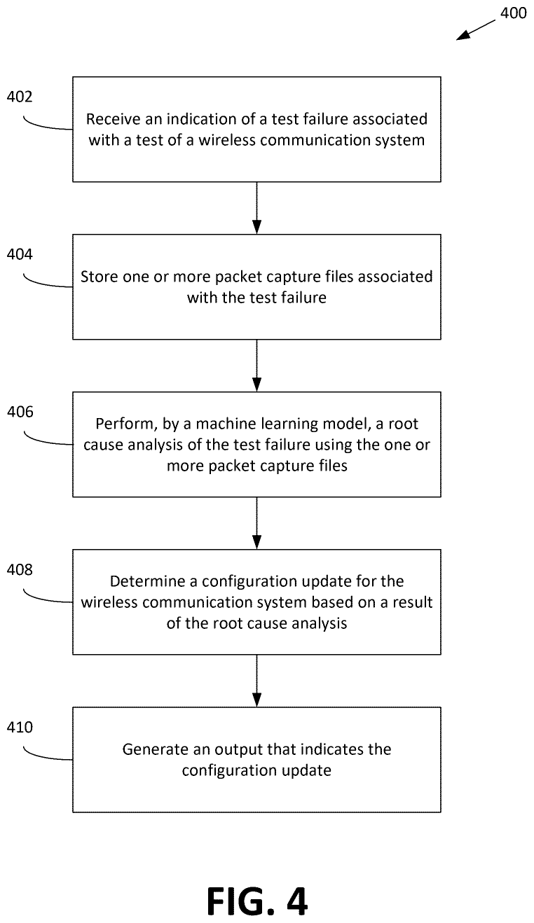

FIG. 4 is a flow diagram of an example method 400 of performing a network test using machine learning, according to at least one embodiment. The method 400 may be performed by processing logic that may comprise hardware (e.g., circuitry, dedicated logic, programmable logic, microcode, etc.), software (such as instructions running on the processor), firmware, or a combination thereof. In one embodiment, a processor of the testing system 200 performs the method 400. Alternatively, other components of the testing system 200, or other disclosed devices, may perform some or all of the operations of the method 400.

With further reference to FIG. 4, the method 400 begins with the processing logic receiving an indication of a test failure associated with a test of a wireless communication system (block 402). The processing logic stores one or more packet capture files associated with the test failure (block 404). The processing logic performs, by a machine learning model, a root cause analysis of the test failure using the one or more packet capture files (block 406). The processing logic determines a configuration update for the wireless communication system based on a result of the root cause analysis (block 408). The processing logic generates an output that indicates the configuration update (block 410).

In some implementations, the processing logic trains a plurality of machine learning models using the one or more packet capture files and stores a plurality of training results, associated with training the plurality of machine learning models, in a machine learning model database. In some implementations, the processing logic selects the machine learning model from a plurality of machine learning models in the machine learning model database based on the one or more packet capture files and based on one or more characteristics of the machine learning model.

In some implementations, the processing logic updates a completion time for the test of the wireless communication system based on the result of the root cause analysis.

In some implementations, the processing logic initiates another test of the wireless communication system based on the configuration update.

In some implementations, the processing logic generates an indication that the machine learning model is not able to perform the root cause analysis of the test failure.

In some implementations, the processing logic provides the output that indicates the configuration update to a user input component, wherein the user input component enables a user to initiate another test of the wireless communication system.

In some implementations, the processing logic provides the output that indicates the configuration update to a repository, wherein the repository includes information from one or more historical tests of the wireless communication system.

In some implementations, a system comprises one or more processors, and one or more memories, coupled with the one or more processors, storing processor-readable instructions which, when executed by the one or more processors, cause the one or more processors to perform one or more operations of the method 400.

In some implementations, a non-transitory computer-readable storage medium comprises instructions that, when executed by a processing device, cause the processing device to perform operations one or more operations of the method 400.

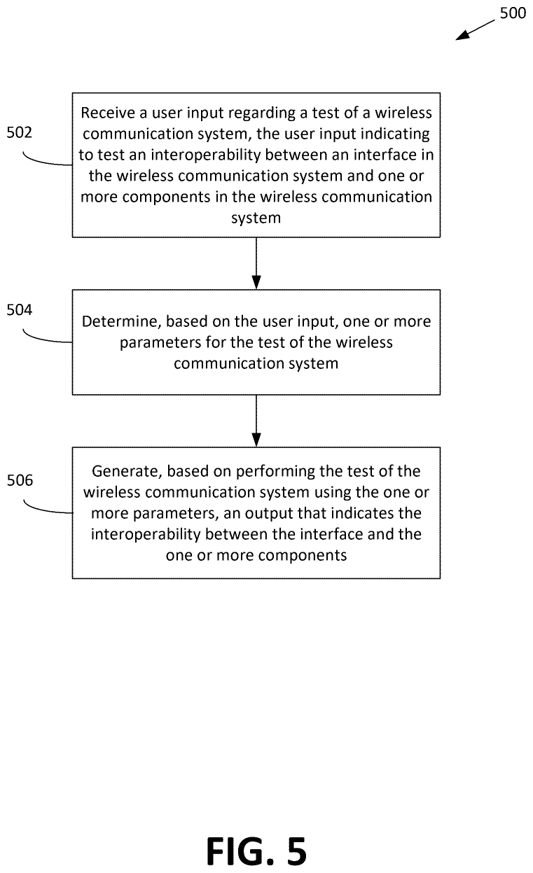

FIG. 5 is a flow diagram of an example method 500 of performing a network test to determine an interoperability between two or more components in a network, according to at least one embodiment. The method 500 may be performed by processing logic that may comprise hardware (e.g., circuitry, dedicated logic, programmable logic, microcode, etc.), software (such as instructions running on the processor), firmware, or a combination thereof. In one embodiment, a processor of the testing system 200 performs the method 500. Alternatively, other components of the testing system 200, or other disclosed devices, may perform some or all of the operations of the method 500.

With further reference to FIG. 5, the method 400 begins with the processing logic receiving an indication of a test failure associated with a test of a wireless communication system (block 502). The user input may indicate to test an interoperability between an interface in the wireless communication system and one or more components in the wireless communication system. The processing logic determines, based on the user input, one or more parameters for the test of the wireless communication system (block 504). The processing logic generates, based on performing the test of the wireless communication system using the one or more parameters, an output that indicates the interoperability between the interface and the one or more components (block 506).

In some implementations, the wireless communication system is an ORAN wireless communication system. In some implementations, the interface is an ORAN interface, and the one or more components include one or more other ORAN interfaces.

In some implementations, the interface is an OFH interface, an OMH interface, an OBH interface, an RIC interface, an SMO interface, or an Xn interface. In some implementations, the OFH interface is a management plane OFH interface, a control plane OFH interface, a user plane OFH interface, or a synchronization plane OFH interface, the OMH interface is a control plane F1 interface or a user plane F1 interface, the OBH interface is a control plane NG interface or a user plane NG interface, the RIC interface is an E2 interface or an A1 interface, the SMO interface is an O1 interface or an O2 interface.

In some implementations, the one or more parameters include at least one of a functional test parameter, a protocol test parameter, a performance test parameter, or a security test parameter. In some implementations, the functional test parameter indicates a connection property, a data transfer property, or a handover property associated with communications between the interface and the one or more components in the wireless communication system, the protocol test parameter indicates a signaling message property, an error handling property, or a protocol compliance property associated with communications between the interface and the one or more components in the wireless communication system, the performance test parameter indicates a network load property, a mobility property, or an interference property associated with communications between the interface and the one or more components in the wireless communication system, and the security test parameter indicates a vulnerability property, an encryption property, or a communication security property associated with communications between the interface and the one or more components in the wireless communication system.

In some implementations, the test of the wireless communication system is performed in a testing environment or a laboratory environment.

In some implementations, the output that indicates the interoperability between the interface and the one or more components in the wireless communication system includes a pass condition or a fail condition.

In some implementations, the output that indicates the interoperability between the interface and the one or more components in the wireless communication system includes a value that indicates a level of interoperability between the interface and the one or more components in the wireless communication system.

In some implementations, the processing logic determines, based on the user input, a testing resource for the test of the wireless communication system, and initiates the test of the wireless communication system using the testing resource. In some implementations, the processing logic adds the test of the wireless communication system to a queue based on the testing resource not being available or not having end-to-end connectivity.

In the above description, numerous details are set forth. It will be apparent, however, to one of ordinary skill in the art having the benefit of this disclosure, that aspects may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
receiving a user input regarding a test of a wireless communication system;
identifying, based on the user input, user information and repository information, wherein the user information comprises an intent of the user input and the repository information comprises configuration information that is based on one or more historical tests of the wireless communication system;
determining, based on the user input, the user information, and the repository information, a testing resource for the test of the wireless communication system; and
initiating the test of the wireless communication system using the testing resource.

2. The method of claim 1, wherein the user input regarding the test of the wireless communication system indicates to test at least one of an interoperability between two or more nodes in the wireless communication system, a capacity of the wireless communication system, a performance metric of the wireless communication system, a conformance of the wireless communication system, a security of the wireless communication system, or a device that is communicating with the wireless communication system.

3. The method of claim 1, further comprising identifying, based on the user input, the user information, and the repository information, an environment for performing the test of the wireless communication system or a quantity of nodes to be tested during the test of the wireless communication system.

4. The method of claim 1, wherein determining the testing resource for the test of the wireless communication system comprises determining whether the testing resource is available and has end-to-end connectivity.

5. The method of claim 4, further comprising adding the test of the wireless communication system to a queue based on the testing resource not being available or not having end-to-end connectivity.

6. The method of claim 1, wherein initiating the test of the wireless communication system comprises sending, to a test orchestration and reporting component, an indication to initiate the test of the wireless communication system, wherein the indication to initiate the test of the wireless communication system comprises at least one of driver information or firmware information for the test of the wireless communication system.

7. The method of claim 1, further comprising identifying, based on the intent of the user input and a set of test cases associated with the wireless communication system, a plurality of test cases in the set of test cases to be performed during the test of the wireless communication system.

8. The method of claim 1, wherein the user information further comprises at least one of artifact information or configuration information associated with a user of the wireless communication system.

9. The method of claim 1, wherein the repository information further comprises at least one of test suite information, inventory information, or reference stack information.

10. The method of claim 1, further comprising sending, to a user associated with the user input, an indication of a date or a time at which at least a portion of the test is to be completed.

11. The method of claim 1, further comprising sending, to a user associated with the user input, after a completion of the test of the wireless communication system, a status indicator for the test of the wireless communication system and summary report for the test of the wireless communication system.

12. The method of claim 11, wherein the summary report indicates, for each test case of a plurality of test cases associated with the test of the wireless communication system, an indication of a pass condition for the test case or an indication of a fail condition for the test case and an indication of one or more log files for the test case.

13. The method of claim 1, further comprising generating an output that indicates one or more configuration changes to the wireless communication system based on a fail condition for the test of the wireless communication system.

14. The method of claim 1, further comprising identifying, using a machine learning model, based on the user input, the user information, and the repository information, one or more parameters for the test of the wireless communication system.

15. The method of claim 14, wherein the one or more parameters for the test of the wireless communication system include a date or a time at which the test of the wireless communication system is to be performed.

16. The method of claim 14, wherein the one or more parameters for the test of the wireless communication system include a likelihood of a pass condition for the test of the wireless communication system or a likelihood of a fail condition for the test of the wireless communication system.

17. The method of claim 14, further comprising sending, to a user associated with the user input, prior to completing the test of the wireless communication system, an indication of the one or more parameters for the test of the wireless communication system.

18. The method of claim 14, further comprising accessing ticketing information that indicates at least one of a quantity of other tests being performed and a quantity of testing resources that are available.

19. A system comprising:
one or more processors; and
one or more memories, coupled with the one or more processors, storing processor-readable instructions which, when executed by the one or more processors, cause the one or more processors to perform operations comprising:
receiving a user input regarding a test of a wireless communication system;
identifying, based on the user input, user information and repository information, wherein the user information comprises an intent of the user input and the repository information comprises configuration information that is based on one or more historical tests of the wireless communication system;
determining, based on the user input, the user information, and the repository information, a testing resource for the test of the wireless communication system; and
initiating the test of the wireless communication system using the testing resource.

20. A non-transitory computer-readable storage medium comprising instructions that, when executed by a processing device, cause the processing device to perform operations comprising:
receiving a user input regarding a test of a wireless communication system;
identifying, based on the user input, user information and repository information, wherein the user information comprises an intent of the user input and the repository information comprises configuration information that is based on one or more historical tests of the wireless communication system;
determining, based on the user input, the user information, and the repository information, a testing resource for the test of the wireless communication system; and
initiating the test of the wireless communication system using the testing resource.
